(19) United States
(12) Patent Application Publication
(10) Pub. No.: US 2025/0078052 A1
(43) Pub. Date: Mar. 6, 2025

(54) System and Method for Enabling Batch Payments

(71) Applicant: PERPETUAL BLOCK AG, Zug (CH)

(72) Inventor: Rahul Malu, Pune (IN)

(21) Appl. No.: 18/241,962

(22) Filed: Sep. 4, 2023

(51) Int. Cl. G06Q 20/10; G06Q 20/36; G06Q 20/38; G06Q 20/40

(52) U.S. Cl. CPC G06Q 20/10; G06Q 20/367; G06Q 20/381; G06Q 20/3825; G06Q 20/405; G06Q 2220/00

(57) ABSTRACT

System and method for transacting over a network for making a batch payment from a single buyer to a plurality of recipients in a list of recipients are provided. The system comprises a smart contract, an execution module and a transaction timing module. The transaction timing module periodically calculates and checks the gas costs involved in the transaction, compares the calculated gas cost with a predetermined average value, and activates the execution module to execute the transaction when the calculated gas costs is less than the predetermined average value. The invention leverages the inherent nature of blockchain along with the power of smart contracts to enable payment to multiple recipients (batch payment, split payment to multiple recipients) and to make the overall payment flow very transparent, seamless, cost-effective, time optimised along with the support for an intermediary less (non-custodial) way of payment.

### FIELD OF THE INVENTION

The present invention relates to cryptocurrency payment systems and more particularly to system and method for making batch payments in cryptocurrency payment systems.

### BACKGROUND OF THE INVENTION

E-commerce (electronic commerce) is the activity of electronically buying or selling of products/online services over the Internet. E-commerce draws on technologies such as mobile commerce, electronic funds transfer, supply chain management, Internet marketing, online transaction processing, electronic data interchange (EDI), inventory management systems, and automated data collection systems.

Usually, the role of a marketplace (such as E-Commerce/Data/Service marketplace, etc) is to enable trade between a buyer and seller (Merchant/Service provider). The buyer (Payer) is the one who initiates a payment transaction to purchase the specified goods/services. Generally, the marketplace platform has to take custody of the funds transferred from the buyer and subsequently transfer the funds to the respective seller/s after deducting commissions/handling fees etc. In the present times, crypto payment based ecommerce marketplaces are growing significantly since Cryptocurrencies, such as Bitcoin and Ethereum, have gained substantial popularity as mediums of exchange and stores of value. In an ecommerce marketplace setup,

It may be the case that single buyer buys a number (plurality) of goods and/or services, which are provided by different independent sellers on the market place platform. That is to say, for a single buyer buying ten (say) products or services at a single market place, there may be at least two and sometimes up to ten sellers involved. From the buyer's perspective, it remains a single payment transaction (which is a total of the combined value of all the goods/services bought plus the marketplace fees). But from the perspective of the marketplace, every purchase has to be processed individually at least for each seller involved. Besides, the payment made by the buyer needs to be split amongst multiple parties (self-commission, payments to multiple sellers individually, etc.).

However, the existing cryptocurrency payment systems face operational inefficiencies when it comes to executing batch payments over the ecommerce marketplace. Batch payments refer to the process of executing multiple payments within a single transaction. In traditional fiat payment systems, batch payments are accomplished seamlessly by consolidating multiple payment requests into a single transaction, reducing both time and cost. However, in cryptocurrency payment systems, the execution of batch payments necessitates separate transactions for each payment request, leading to increased gas fees and longer processing times.

Although the payer may have the sufficient equivalent amount to pay all the recipients but he may not have the same in the respective currency/currencies acceptable to the recipients. In such scenarios, the payment process involves multiple steps such as:
Calculate respective amounts after converting from the base currency (held by the Payer) to respective currencies accepted by the recipients.
Conversion of amount from base currency to multiple currencies.
Executing separate transactions for each recipient in the currency accepted by them.

The current approach not only incurs higher costs for users due to gas fees associated with each transaction but also hampers the scalability and efficiency of blockchain networks. Further, there are regulatory issues involved. As the marketplace platform, intermediaries and the like have to take custody of the complete amount received from the Payer before the same is transferred to the recipients, it may require a Money transfer License (MTL/Banking license) in order to operate in a compliant way.

Also, as the funds are held by the intermediary (Marketplace), there is an undesired outstanding liability of the funds with the marketplace. In events such as attacks/hacks, or operational issues with the team handling payment of transactions, the funds might get lost or the transactions may be delayed and can take really long to get processed.

Therefore, there is a need for systems and methods for enabling split transaction and batch payments in a crypto payment enabled market place which over comes at least one of the above disadvantages.

### SUMMARY OF THE INVENTION

An object of the invention is to provide system and method for making a batch payment from a single buyer to a plurality of recipients in cryptocurrency payment systems

Another object of the invention is provide a platform which leverages the inherent nature of blockchain along with the power of smart contracts to enable payment to multiple recipients (batch payment, split payment to multiple recipients).

Another object of the invention is to make the overall payment flow very transparent, seamless, cost-effective, time-optimised along with the support for an intermediary less (non-custodial) way of payment.

Accordingly, in one aspect the invention provides a system and method for enabling split transaction and batch payments in a crypto payment enabled market place. In accordance with an embodiment, the system comprises a smart contract deployed on a blockchain and a transaction timing module, wherein the smart contract further comprises an execution module The smart contract includes one or more terms of a transactions. The execution module completes the transaction based upon the one or more terms in the smart contract. The transaction timing module periodically calculates and checks gas costs involved in the transaction, compares the calculated gas cost with a predetermined average value, and activates the execution module to execute the transaction when the calculated gas costs is less than the predetermined average value.

The smart contract includes parameters associated with the batch payment for the transaction. The parameters include a source token address, an amount value of the source token, a signed transaction from the payer, and details of each of the recipients in the list of recipients.

In an embodiment, the execution module is configured to initiate transfer of tokens for each of the recipients. The execution module checks based upon the smart contract parameters, if a currency change is required for any of the recipient in the list of recipients; and transfers a respective token to each recipient in the list of recipients. The system includes a decentralised exchange to convert the payment amount from a first currency to a second currency based upon the result of the checking whether the currency change is required.

In an embodiment, the system includes an approval module to compare the payment to be made with a spending allowance; and allowing the payment to go through only based upon the comparison. The spending allowance may be a part of the parameters received by the smart contract.

In an embodiment, the system includes a transfer module to transfer the token from the original spender to the recipient.

In another aspect, the invention provides a method for making a batch payment from a single buyer to a plurality of recipients in a list of recipients when transacting over a network. In accordance with an embodiment, the method comprises deploying a smart contract which includes terms of the transaction in a block chain environment, executing the transaction by completing the transaction based upon the terms in the smart contract; and timing the execution of the transaction based upon a gas cost. The step of timing the execution includes periodically calculating, at predetermined intervals of time, the gas costs involved in the transaction; comparing the calculated gas cost with a predetermined average value; and activating the execution module to execute the transaction when the calculated gas costs is less than the predetermined average value.

In an embodiment, the method includes receiving, by the smart contract, parameters associated with the batch payment for the transaction, and signing, by the payer, of the transaction.

In an embodiment, the step of executing the transaction includes initiating transfer of tokens for each of the recipients, wherein: checking, based upon the smart contract parameters, if a currency change is required for any of the recipient in the list of recipients; and transferring a respective token to each recipient in the list of recipients. The method comprises converting, based upon the result of the checking if the currency change is required, the payment amount for a recipient from a first currency to a second currency using the decentralised exchange,

In an embodiment, the method comprises comparing the payment to be made with a spending allowance and allowing the payment to go through based upon the comparison. The spending allowance is a part of the parameters received by the smart contract. The method further comprises transferring the token from the original spender to the recipient.

### BRIEF DESCRIPTION OF THE DRAWINGS

The method and system are illustrated in the accompanying drawings, throughout which like reference letters indicate corresponding parts in the various drawings. The invention herein will be better understood from the following description with reference to the drawings, in which:

FIG. 1 is a block diagram illustrating a system for transacting over a network for making a batch payment from a single buyer to a plurality of recipients in a list of recipients, in accordance with an embodiment of the invention.

FIG. 2A is a flowchart illustrating a method for transacting over a network, in accordance with an embodiment of the invention.

FIG. 2B is a flowchart illustrating the method for transacting over a network, in accordance with an embodiment of the invention.

FIG. 2C is a flowchart illustrating the method for transacting over a network, in accordance with an embodiment of the invention.

FIG. 3 is a block diagram illustrating an exemplary process flow of the system for making the batch payment from the single buyer to the plurality of recipients in the list of recipients, in accordance with an embodiment of the invention.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these implementations only. Numerous modifications, changes, variations, substitutions and equivalents will be apparent to those skilled in the art, without parting from the scope of the invention. The accompanying drawings are used to help easily understand various technical features and it should be understood that the implementations presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Various embodiments of the invention provide a system and method for transacting over a network for making a batch payment from a single buyer to a plurality of recipients in a list of recipients.

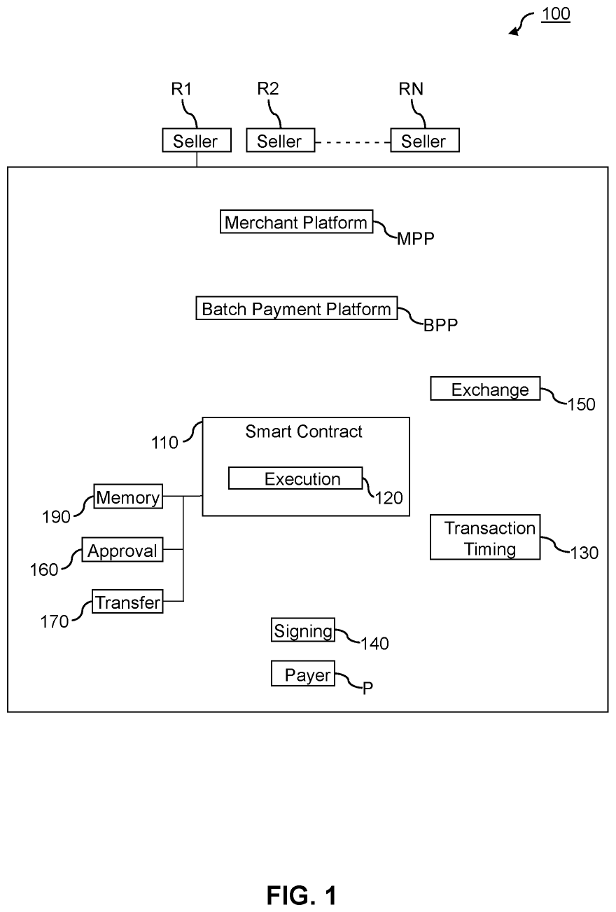

FIG. 1 is a block diagram illustrating a system (100) for executing a transaction for batch payment from a single buyer to a plurality of recipients in a list of recipients, in accordance with an embodiment of the invention.

Referring to FIG. 1, the buyer (Payer P) is the one who initiates a payment transaction to purchase goods/services from the Marketplace platform (MPP). A batch payment platform (BPP) enables transfer of funds for the transaction from the buyer (Payer P) to the respective seller/s-Recipients (R1-Rn), after deducting the commissions/fees etc. by the market place (MPP), if any.

The system (100) comprises a smart contract (110) comprising an execution module (120), and a transaction timing module (130). The smart contract (110) includes terms of the transaction and is deployed in a block chain and the execution module (120) completes the transaction based upon the terms in the smart contract (110).

The system (100) leverages the inherent nature of blockchain along with the power of smart contracts to enable payment to multiple recipients (batch payment, split payment to multiple recipients). A blockchain is a distributed ledger with growing lists of records (blocks) that are securely linked together via cryptographic hashes. Each block contains a cryptographic hash of the previous block, a timestamp, and transaction data (generally represented as a Merkle tree, where data nodes are represented by leaves). Since each block contains information about the previous block, they effectively form a chain (compare linked list data structure), with each additional block linking to the ones before it. Consequently, blockchain transactions are irreversible in that, once they are recorded, the data in any given block cannot be altered retroactively without altering all subsequent blocks. The smart contract (110) is deployed on a public blockchain. An example of blockchain platform may be Ethereum.

A gas fee is a blockchain transaction fee, paid to network validators for their services to the blockchain. Without the fees, there would be no incentive for anyone to stake their ETH and help secure the network. The transaction timing module (130) periodically calculates and checks the gas costs involved in the transaction, compares the calculated gas cost with a predetermined average value, and activates the execution module (120) to execute the transaction when the calculated gas costs is less than the predetermined average value. The transaction costs in blockchain (gas costs) fluctuates a lot and the sender has to bear the cost of the transaction costs when submitting it to the blockchain. The transaction timing module (130) enables the sender (Payer P) to schedule the transaction at a time when the blockchain network gas costs are usually lowest.

The smart contract (110) includes a business logic to receive the parameters required to process the batch payment. The smart contract (110) includes parameters associated with the transaction for batch payment. In an embodiment, the parameters include a source token address (identifier) (Currency), an amount value of the source token, a signed transaction from the payer, and details of each of the recipients in the list of recipients. The details pertaining to each of the recipients include list of the recipients, a respective amount that is to be paid to each of the recipients, and the respective currency in which the recipient accepts the payment. It may be apparent that more aspects may be added as per requirement to list of the parameters which may be relevant to the transaction process.

With the help of the batch payment functionality, the buyer (Payer P) only needs to sign the transaction once and is able to split the token amount and transfer the same to all the recipients (R1-Rn) at once. The signed transaction can be stored and submitted later depending on the time of the day when the gas fees are the lowest.

In an embodiment, the execution module (120) is configured to initiate transfer of tokens for each of the recipients (R1-Rn). The execution module (120) checks, based upon the smart contract parameters, if a currency change is required for any of the recipient in the list of recipients; and transfers a respective token to each recipient in the list of recipients (R1-Rn).

The buyer (Payer P) may have the sufficient equivalent amount to pay all the recipients (R1-Rn) but in a different currency from what the recipients are willing to accept. The system (100) further includes a decentralised exchange (150) to convert the payment amount for a recipient (say R1) from a first currency to a second currency based upon the result of the checking whether the currency change is required.

In an embodiment, the system (100) includes an approval module (160) to compare the payment to be made with a spending allowance; and allows the payment to go through only based upon the comparison. In an embodiment, the spending allowance is a part of the parameters of the smart contract (110).

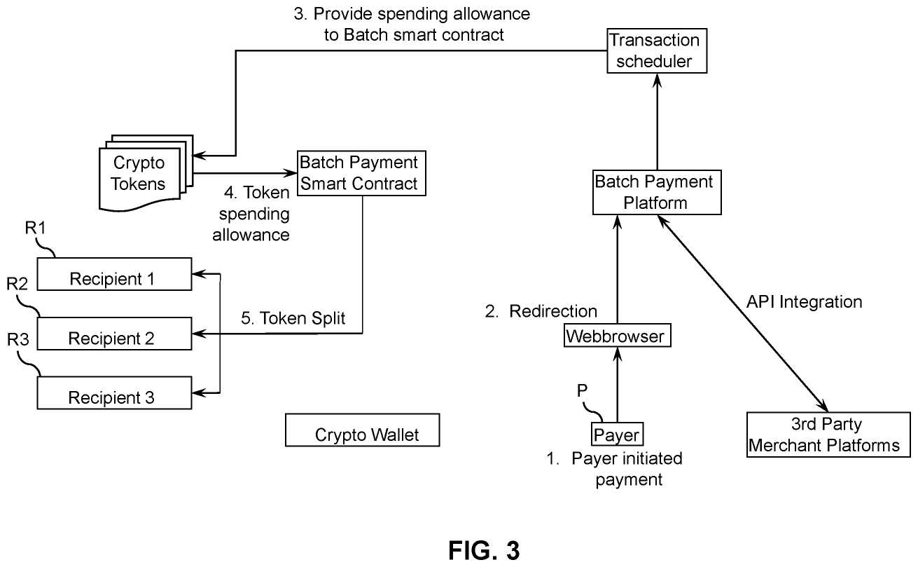

FIG. 3 is a block diagram illustrating an exemplary process flow of the system for making the batch payment from the single buyer to the plurality of recipients in the list of recipients, in accordance with an embodiment of the invention. Payer (P) initiates the purchase and payment. The web browser redirects the payment process to the batch payment platform (BPP). A Transaction scheduler (such as the transaction timing module 130) times the transaction/payment. Referring to FIG. 1 and FIG. 5, in an embodiment, the smart contract includes a transfer module (170) to transfer the token from the original spender (Payer P) to the recipient (one of R1-Rn). During the execution of the smart contract (110), the transfer module (170) iterates through the list of recipients (R1-R3 as shown in the example in FIG. 5), respective amounts and currencies and initiates the transfer of tokens.

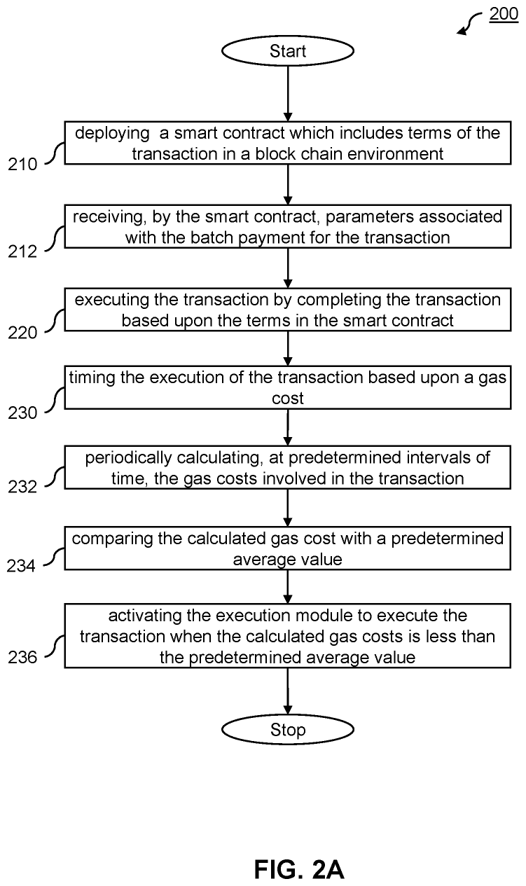

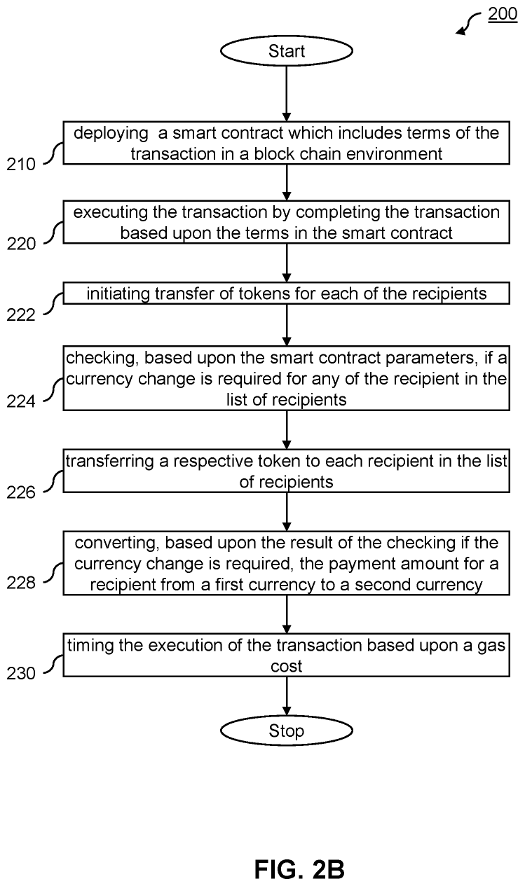

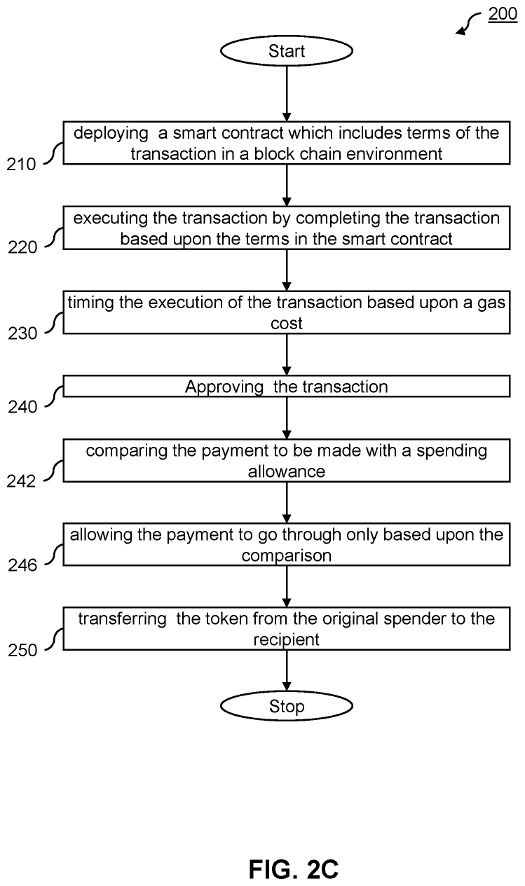

FIG. 2A is a flowchart illustrating a method (200) for transacting over a network, in accordance with an embodiment of the invention. The method (200) comprises deploying (210) a smart contract which includes terms of the transaction in a block chain environment, executing (220) the transaction by completing the transaction based upon the terms in the smart contract; and timing (230) the execution of the transaction based upon a gas cost.

The step of timing (230) the execution includes periodically calculating (232), at predetermined intervals of time, the gas costs involved in the transaction; comparing (234) the calculated gas cost with a predetermined average value; and activating (236) the execution module to execute the transaction when the calculated gas costs is less than the predetermined average value.

In an embodiment, the method includes receiving (212), by the smart contract, parameters associated with the batch payment for the transaction. The method (200) comprises signing, by the payer, of the transaction. The business logic of the batch payment smart contract (110) is designed in such a way that only the payer can invoke the batch payment transaction which initiates the token transactions from Payer's wallet to the respective recipients. The method (200) comprises storing the signed transaction from the payer in a memory unit.

FIG. 2B is a flowchart illustrating the method for transacting over a network, in accordance with an embodiment of the invention. Referring to FIG. 2b, in an embodiment, the step of executing (220) the transaction includes initiating (222) transfer of tokens for each of the recipients, wherein: checking (224), based upon the smart contract parameters, if a currency change is required for any of the recipients (R1-Rn) in the list of recipients; and transferring (226) a respective token to each recipient (R1-Rn) in the list of recipients (R1-Rn). The method (200) comprises converting (228), based upon the result of the checking if the currency change is required, the payment amount for a recipient (R1-Rn) from a first currency to a second currency using the decentralised exchange (150).

For example, if there is a need to convert the tokens, this can be done by the integration of decentralised exchanges such as decentralised exchange (150) within the batch payment smart contract (110). Inside decentralised exchanges, there are different swap pairs for multiple token combinations and the same is supported with the help of liquidity pools.

FIG. 2C is a flowchart illustrating the method for transacting over a network, in accordance with an embodiment of the invention. Referring to FIG. 2C, in an embodiment, the method comprises a step of approving (240) the transaction. As an example, the standard “approve” method of the ERC20 standard token is used to provide spending allowance to the batch payment smart contract (110) that is deployed on the public blockchain. This is done using the approve( ) method which is implemented in all ERC-20-compliant utility tokens. ERC-20 is a token standard for minting, and transacting utility tokens. The approve ( ) transaction needs to be signed by the token holder (Payer P) who needs to transfer the tokens to the required recipients.

The step of approving (240) comprises comparing (242) the payment to be made with a spending allowance and allowing (244) the payment to go through only based upon the comparison. The spending allowance is a part of the parameters received by the smart contract. For example, an allowance of sufficient amount is provided to the batch payment smart contract (110).

In an embodiment, the method (200) comprises transferring (250) the token from the original spender to the recipient. For example, after the approval, the buyer (Payer P) can use the transferFrom( ) method of ERC-20 standard to transfer the tokens on behalf of the original spender. The batch payment smart contract (110) has the ability to transfer funds (crypto token) from the Payer's wallet to any destination. Inside the batch payment smart contract (110), the method (200) iterates over the list of all recipients and initiates transferring (250) of the token to each of the recipients with the respective amounts. The method of the invention is also fault-tolerant and makes sure that all the internal transactions (batch payment) are completed successfully. In an embodiment, if any of the internal steps/transactions fails, the system cancels all the transactions.

It may be appreciated that all the steps which include forming a transaction request, signing the transaction using Payer's wallet (Keys), transaction submission, currency conversion, and batch payment to multiple recipients are done within a single blockchain transaction.

Advantageously, the invention provides a platform which leverages the inherent nature of blockchain along with the power of smart contracts to enable payment to multiple recipients (batch payment, split payment to multiple recipients) and to make the overall payment flow very transparent, seamless, cost-effective, time optimised along with the support for an intermediary less (non-custodial) way of payment. With the help of the batch payment functionality, a payer only needs to sign the transaction once and is able to split the token amount and transfer the same to thousands of recipients at once. This approach is also fault-tolerant and the process makes sure that all the internal transactions (batch payment) are completed successfully. If any of the internal steps/transactions fails, the system cancels all the transactions.

The system also enables the sender (Payer) to schedule a batch transaction to a time when the blockchain network gas costs are usually lowest. The invention provides for saving gas costs and time. It obviates the requirement of intermediaries as it is based upon a P2P model (Non-custodial) as funds are directly transferred from the Payer's wallet to the wallets of all the payees.

While the above detailed description has shown, described, and pointed out novel features as applied to various implementations, it can be understood that various omissions, substitutions, and changes in the form and details of the devices or algorithms illustrated can be made without departing from the scope of the disclosure. As can be recognized, certain implementations described herein can be embodied within a form that does not provide all of the features and benefits set forth herein, as some features can be used or practiced separately from others.

The foregoing description of the specific implementations will so fully reveal the general nature of the implementations herein that others can, by applying current knowledge, readily modify and/or adapt for various applications such specific implementations without departing from the generic concept, and, therefore, such adaptations and modifications should and are intended to be comprehended within the meaning and range of equivalents of the disclosed implementations. It is to be understood that the phraseology or terminology employed herein is for the purpose of description and not of limitation. Therefore, while the implementations herein have been described in terms of preferred implementations, those skilled in the art will recognize that the implementations herein can be practiced with modification within the spirit and scope of the invention as described herein.

We claim:

1. A system executing a transaction for batch payment from a single buyer to a plurality of recipients in a list of recipients, the system comprising:
a smart contract, the smart contract including terms of the transaction and further comprising an execution module, the execution module completing the transaction based upon the terms in the smart contract; and
a transaction timing module, the transaction timing module being configured to:
periodically calculate and check gas costs involved in the transaction;
comparing the calculated gas cost with a predetermined average value; and
activating the execution module to execute the transaction when the calculated gas costs is less than the predetermined average value.

2. The system according to claim 1, wherein the smart contract is configured to receive parameters associated with the batch payment for the transaction, the parameters comprising at least one chosen from a group consisting of: a source token address, an amount value of the source token, a signed transaction from the payer, and details regarding each of the recipients in the list of recipients.

3. The system according to claim 2, wherein the system includes a signing module for generating the signed transaction by the payer.

4. The system according to claim 1, wherein the execution module is configured to initiate transfer of tokens for each of the recipients, wherein the execution module is configured to:
check, based upon the smart contract parameters, if a currency change is required for any of the recipient in the list of recipients; and
transfer a respective token to each recipient in the list of recipients.

5. The system according to claim 4, wherein the system includes a decentralised exchange, the decentralised exchange is configured to convert a payment amount for a recipient from a first currency to a second currency, the conversion being performed based upon the result of the checking if the currency change is required.

6. The system according to claim 1, wherein the system includes an approval module, the approval module being configured to:
compare the payment to be made with a spending allowance; and
allow the payment to go through only based upon the comparison, the spending allowance being a part of the parameters received by the smart contract.

7. The system according to claim 1, wherein the system includes a transfer module, the transfer module being configured to transfer the token from the original spender to the recipient.

8. A method for executing a transaction for batch payment from a single buyer to a plurality of recipients in a list of recipients, the method comprising steps of:
deploying a smart contract including terms of the transaction and comprising an execution module
executing the transaction by completing the transaction based upon the terms in the smart contract; and
timing the execution of the transaction based upon a gas cost, wherein:
calculating, periodically at predetermined intervals of time, the gas costs involved in the transaction;
comparing the calculated gas cost with a predetermined average value; and
activating the execution module to execute the transaction when the calculated gas costs is less than the predetermined average value.

9. The method according to claim 8 comprising receiving, by the smart contract, parameters associated with the batch payment for the transaction, the parameters comprising at least one of a group consisting of: a source token address, an amount value of the source token, a signed transaction from the payer, and details of each of the recipients in the list of recipients.

10. The method according to claim 8, wherein the step of executing the transaction includes initiating transfer of tokens for each of the recipients, wherein:
a. checking, based upon the smart contract parameters, if a currency change is required for any of the recipient in the list of recipients; and
b. transferring a respective token to each recipient in the list of recipients.

11. The method according to claim 10, wherein the method comprises converting, based upon the result of the checking if the currency change is required, the payment amount for a recipient from a first currency to a second currency using a decentralised exchange.

12. The method according to claim 11, wherein the method comprises a step of approving the transaction, wherein:
comparing the payment to be made with a spending allowance; and
allowing the payment to go through only based upon the comparison, the spending allowance being a part of the parameters received by the smart contract.

13. The method according to claim 8, wherein the method comprises transferring the token from the original spender to the recipient.
